(19) United States
(12) Patent Application Publication
(10) Pub. No.: US 2017/0267031 A1
(43) Pub. Date: Sep. 21, 2017

(54) PNEUMATIC TIRE

(71) Applicant: SUMITOMO RUBBER INDUSTRIES, LTD., Kobe-shi (JP)

(72) Inventor: Ryo OBA, Kobe-shi (JP)

(73) Assignee: SUMITOMO RUBBER INDUSTRIES, LTD., Kobe-shi (JP)

(21) Appl. No.: 15/453,101

(22) Filed: Mar. 8, 2017

(30) Foreign Application Priority Data
Mar. 18, 2016 (JP) 2016-055869

(51) Int. Cl. B60C 11/03; B60C 11/12; B60C 11/04

(52) U.S. Cl. CPC B60C 11/0332; B60C 11/04; B60C 11/125; B60C 2011/0348; B60C 2011/0353; B60C 2011/0355; B60C 2011/036; B60C 2011/0365; B60C 2011/0372

(57) ABSTRACT

A pneumatic tire includes a tread having a shoulder main groove, and a center main groove such that the tread is divided into a shoulder land portion and a middle land portion between the shoulder main groove and center main groove. The shoulder and center main grooves are formed such that a ratio W1/W2 of a tire axial direction width W1 of the shoulder land portion to a tire axial direction width W2 of the middle land portion is in range of 6 to 2.4. The shoulder land portion has a shoulder narrow groove formed on a shoulder main groove side and continuously extending in the tire circumferential direction such that the shoulder narrow groove has groove width smaller than groove width of the shoulder main groove, and the tread is formed such that a first camber amount is in range of 5.3% to 6.5% of tread ground contact width.

### CROSS-REFERENCE TO RELATED APPLICATIONS

The present application is based upon and claims the benefit of priority to Japanese Patent Application No. 2016-055869, filed Mar. 18, 2016, the entire contents of which are incorporated herein by reference.

### BACKGROUND OF THE INVENTION

### Field of the Invention

The present invention relates to a pneumatic tire that improves wear resistance of shoulder land portions while suppressing sideslip on snow and ice.

### Description of Background Art

Japanese Patent Laid-Open Publication No. HEI 9-277804 describes a pneumatic tire in which shoulder narrow grooves are provided in shoulder land portions. The entire contents of this publication are incorporated herein by reference.

### SUMMARY OF THE INVENTION

According to one aspect of the present invention, a pneumatic tire includes a tread having a shoulder main groove continuously extending in a tire circumferential direction on a tread edge side, and a center main groove continuously extending in the tire circumferential direction on a tire axial direction inner side of the shoulder main groove such that the tread is divided into a shoulder land portion on a tire axial direction outer side of the shoulder main groove and a middle land portion between the shoulder main groove and the center main groove. The shoulder main groove and center main groove are formed such that a ratio W1/W2 of a tire axial direction width W1 of the shoulder land portion to a tire axial direction width W2 of the middle land portion is in a range of 6 to 2.4. The shoulder land portion has a shoulder narrow groove formed on a shoulder main groove side and continuously extending in the tire circumferential direction such that the shoulder narrow groove has a groove width smaller than a groove width of the shoulder main groove, and the tread is formed such that a first camber amount is in a range of 5.3% to 6.5% of a tread ground contact width, where the first camber amount is a tire radial direction distance between a tire equator position and a tread edge in a tread profile in a tire cross section that includes a tire rotation axis in a no-load normal state in which the pneumatic tire is mounted to a normal rim and is filled with air at a normal internal pressure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a developed view of a tread part of a pneumatic tire of the present embodiment;

FIG. 2 is a cross-sectional view along an A-A line in FIG. 1;

FIG. 3 is an enlarged view of a shoulder land portion of FIG. 1;

FIG. 4 is a cross-sectional view along a B-B line of FIG. 3;

FIG. 5 is a cross-sectional view along a C-C line of FIG. 3;

FIG. 6 is an enlarged view of a middle land portion of FIG. 1;

FIG. 7A is a cross-sectional view along a D-D line of FIG. 6;

FIG. 7B is a cross-sectional view along an E-E line of FIG. 6;

FIG. 7C is a cross-sectional view along an F-F line of FIG. 6; and

FIG. 8 is a developed view of a tread part of a pneumatic tire of Comparative Example 1.

### DETAILED DESCRIPTION OF THE EMBODIMENTS

The embodiments will now be described with reference to the accompanying drawings, wherein like reference numerals designate corresponding or identical elements throughout the various drawings.

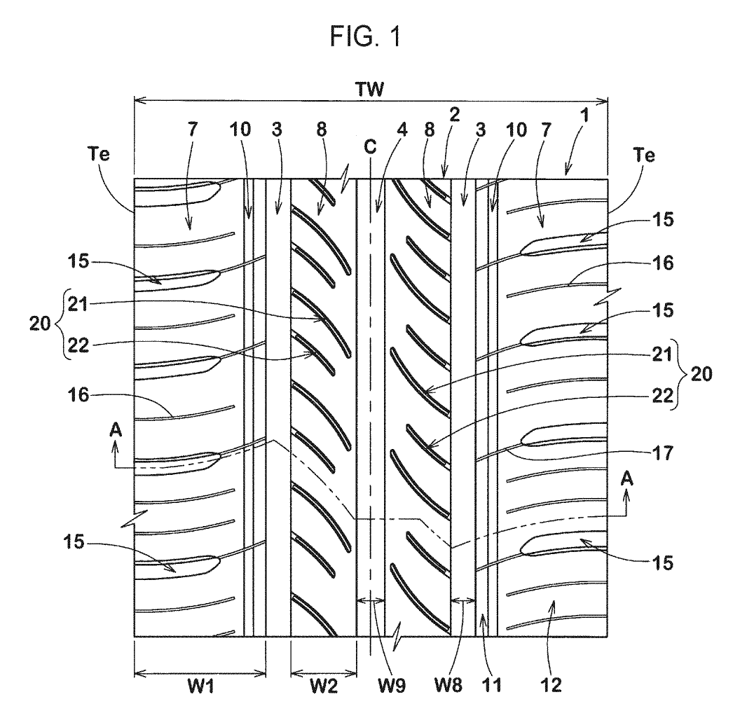

FIG. 1 is a developed view of a tread part 2 of a non-pneumatic tire (hereinafter, may be simply referred to as a “tire”) 1 of the present embodiment. The pneumatic tire 1 of the present embodiment is preferably used, for example, for a passenger car.

As illustrated in FIG. 1, in the tread part 2 of the tire 1, a pair of shoulder main grooves 3 and a center main groove 4 that is arranged between the shoulder main grooves 3 are provided.

The shoulder main grooves 3 respectively continuously extend in a tire circumferential direction on tread edge (Te) sides on both sides of a tire equator (C). The shoulder main grooves 3 of the present embodiment, for example, each linearly extend along the tire circumferential direction. It is also possible that the shoulder main grooves 3, for example, each extend in a wavy or zigzag shape.

The term “tread edges (Te)” refers to ground contact positions of tire axial direction outermost sides when the tire 1 in a normal state, in which the tire 1 is mounted to a normal rim (not illustrated in the drawings) and is filled with air at a normal internal pressure and is loaded with no load, is loaded with a normal load and is grounded on a flat surface at an camber angle of 0 degree. In the present specification, unless otherwise specified, values of dimensions of the parts of the tire are values specified in the normal state.

The term “normal rim” refers to a rim for which standards are set for each tire in a system of standards that includes standards on which the tire is based. For example, the term “normal rim” refers to a “Standard Rim” in the JATMA standards, a “Design Rim” in the TRA standards, or a “Measuring Rim” in the ETRTO standards.

The term “normal internal pressure” refers to an air pressure for which standards are set for each tire in a system of standards that includes the standards on which the tire is based, and refers to a “Highest Air Pressure” in the JATMA standards, a maximum value published in the table “Tire Load Limits at Various Cold Inflation Pressures” in the TRA standards, or an “Inflation Pressure” in the ETRTO standards.

The term “normal load” refers to a load for which standards are set for each tire in a system of standards that includes the standards on which the tire is based, and refers to a “Maximum Load Capacity” in the JATMA standards, a maximum value published in the table “Tire Load Limits at Various Cold Inflation Pressures” in the TRA standards, or a “Load Capacity” in the ETRTO standards.

The center main groove 4 is provided on a tire axial direction inner side of the shoulder main grooves 3. The center main groove 4 continuously extends in the tire circumferential direction. The center main groove 4, for example, linearly extends along the tire circumferential direction. In the present embodiment, one center main groove 4 is provided on the tire equator (C). It is also possible that, for example, two center main grooves 4 are respectively provided on both tire axial direction sides of the tire equator (C).

In order to achieve excellent wet performance while maintaining rigidity of the tread part 2, it is desirable that a groove width (W8) of each of the shoulder main grooves 3 and a groove width (W9) of the center main groove 4 be, for example, 3%-10% of a tread ground contact width (TW). The tread ground contact width (TW) is a tire axial direction distance between the tread edges (Te, Te) of the tire 1 in the normal state.

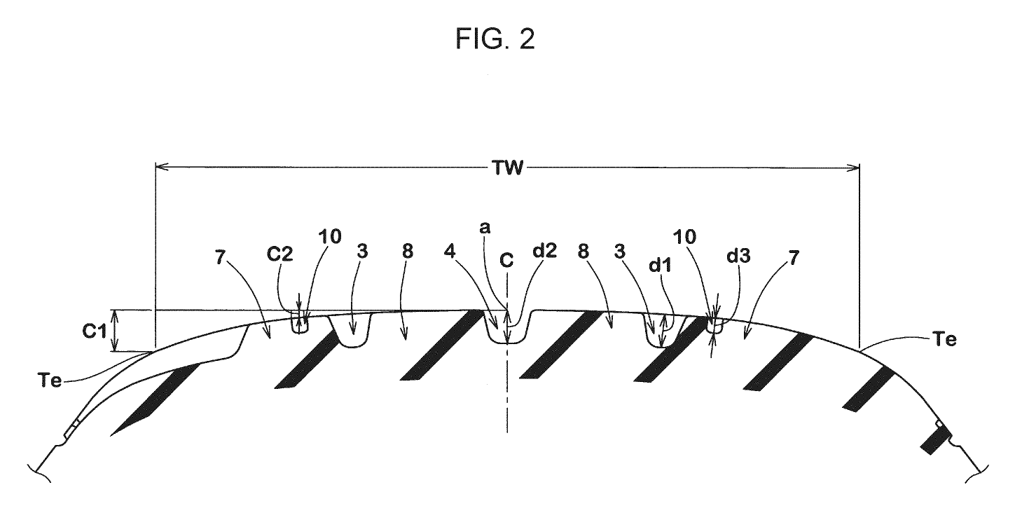

FIG. 2 illustrates a cross-sectional view along an A-A line in FIG. 1. As illustrated in FIG. 2, it is desirable that a depth (d1) of the shoulder main grooves 3 and a depth (d2) of the center main groove 4 be, for example, 5-15 mm when the tire is for a passenger car.

As illustrated in FIG. 1, the tread part 2 is divided into a pair of shoulder land portions 7 and a pair of middle land portions 8. The shoulder land portions 7 are respectively provided on tire axial direction outer sides of the shoulder main grooves 3. The middle land portions 8 are respectively provided on both sides of the tire equator (C) between the shoulder main grooves 3 and the center main groove 4. In the tread pattern of the present embodiment, the grooves and the land portions are respectively formed substantially point symmetrical with respect to a point on the tire equator (C). However, the present invention is not limited to this mode. For example, it is also possible that the tread pattern is structured to be line symmetrical with respect to the tire equator (C).

A ratio (W1/W2) of a tire axial direction width (W1) of each of the shoulder land portions 7 to a tire axial direction width (W2) of each of the middle land portions 8 is in a range of 1.6-2.4. Since the shoulder land portions 7 each have a width as large as 1.6-2.4 times the width of each of the middle land portions 8, the shoulder land portions 7 have higher rigidity than the middle land portions 8 and thus can achieve excellent wear resistance. When the ratio (W1/W2) is smaller than 1.6, the width (W1) of each of the shoulder land portions 7 becomes relatively small and the wear resistance of the shoulder land portions 7 may decrease. When the ratio (W1/W2) is larger than 2.4, the width (W2) of each of the middle land portions 8 becomes relatively small, which may cause uneven wear in a middle portion of the tread part 2.

It is desirable that the width (W1) of each of the shoulder land portions 7 be, for example, 0.25-0.35 times of the tread ground contact width (TW). It is desirable that the width (W2) of each of the middle land portions 8 be, for example, 0.10-0.20 times of the tread ground contact width (TW).

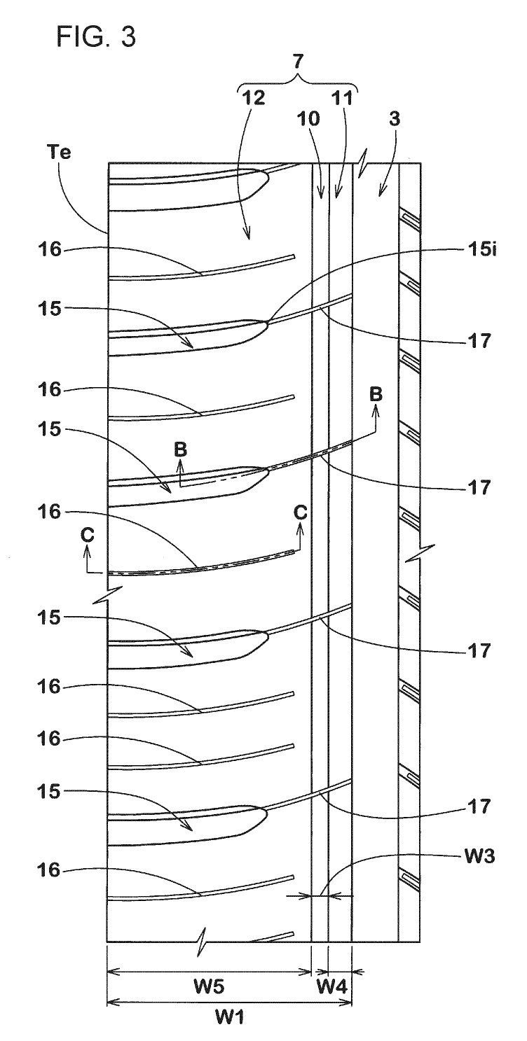

FIG. 3 illustrates an enlarged view of a shoulder land portion 7. As illustrated in FIG. 3, in each of the shoulder land portions 7, on a shoulder main groove 3 side, a shoulder narrow groove 10 that continuously extends in the tire circumferential direction with a groove width (W3) smaller than the groove width (W8) of each of the shoulder main grooves 3 is provided. The shoulder narrow grooves 10 of the present embodiment, for example, each linear extend. However, without being limited to this, it is also possible that the shoulder narrow grooves 10 each extend in a zigzag or wavy shape.

When traveling on snow and ice, edges of the shoulder narrow grooves 10 provide a large frictional force in the tire axial direction to the shoulder land portions 7 that each have a large width, and thus help to prevent sideslip on snow and ice. More detailed structures of the shoulder narrow grooves 10 and the shoulder land portions 7 will be described later.

FIG. 2 illustrates a tread profile in a tire cross section including a tire rotation axis in a no-load normal state in which the tire is mounted to a normal rim and is filled with air at a normal internal pressure. Here, in an embodiment of the present invention, a first camber amount (C1), which is a tire radial direction distance between a tire equator position (a) and a tread edge (Te), is set to 5.3%-6.5% of the tread ground contact width (TW). The term “tread profile” means an outer contour line of the tread part 2 in a state in which the grooves provided in the tread part 2 are filled so as to be smoothly continuous with tread surfaces of the land portions.

In general, when the first camber amount (C1) is small, a ground contact pressure acting on the shoulder land portions 7 tends to be large. On the other hand, when the first camber amount (C1) is large, the ground contact pressure acting on the shoulder land portions 7 tends to decrease and a ground contact pressure acting on the middle land portions 8 tends to increase. In a conventional pneumatic tire, the first camber amount (C1) is often set to 5.0% or less of the tread ground contact width (TW). In this case, a relatively large ground contact pressure is likely to act on the shoulder land portions 7, and thus the shoulder land portions 7 tend to wear out earlier than the middle land portions 8.

An optimal first camber amount (C1) for making a wear amount of the shoulder land portions 7 and a wear amount of the middle land portions 8 substantially uniform can vary depending on and has a certain relationship with the ratio of the width (W1) of each of the shoulder land portions 7 to the width (W2) of each of the middle land portions 8.

In an embodiment of the present invention, by specifying the width (W1) of each of the shoulder land portions 7 in the above-described range and setting the first camber amount (C1) to 5.3%-6.5% of the tread ground contact width (TW), which is larger than that in a conventional tire, the ground contact pressure acting on the shoulder land portions 7 can be appropriately dispersed to the middle land portions 8 side. Therefore, the wear resistance of the shoulder land portions 7 can be improved.

In order to further enhance the above-described effect, it is desirable that the first camber amount (C1) be, for example, 5.6%-6.2% of the tread ground contact width (TW).

In the tread profile, a second camber amount (C2), which is a tire radial direction distance between the tire equator position (a) and a groove center position of a shoulder narrow groove 10, is preferably 0.5% or more and 2.5% or less of the tread ground contact width (TW), and more preferably 1.0% or more and 2.0% or less of the tread ground contact width (TW). By setting the second camber amount (C2) to such a small value, a ground contact pressure acting on a tire axial direction inner side of the shoulder land portions 7 can be appropriately ensured. When the second camber amount (C2) is less than 0.5% of the tread ground contact width (TW), the ground contact pressure acting on the shoulder land portions 7 may become excessively large. When the second camber amount (C2) is larger than 2.5% of the tread ground contact width (TW), the ground contact pressure acting one the tire axial direction inner side of the shoulder land portions 7 may be excessively small.

In order to achieve excellent performance on snow and ice while maintaining the rigidity of the shoulder land portions 7, a depth (d3) of the shoulder narrow grooves 10 is preferably 0.34 or more and 0.47 or less times the depth (d1) of the shoulder main grooves 3, and more preferably 0.38 or more and 0.42 or less times the depth (d1) of the shoulder main grooves 3.

In order to achieve both good steering stability on a dry road surface and good performance on snow and ice in a well-balanced manner, as illustrated in FIG. 3, it is desirable that the groove width (W3) of each of the shoulder narrow grooves 10 be, for example, 0.5%-1.5% of the tread ground contact width (TW) (illustrated in FIG. 1; the same applies hereinafter).

Each of the shoulder land portions 7 includes an inner-side portion 11 that is positioned on a tire axial direction inner side of the shoulder narrow groove 10 and an outer-side portion 12 that is positioned on a tire axial direction outer side of the shoulder narrow groove 10.

In the inner-side portion 11, for example, only sipes are provided, and transverse grooves for drainage are not provided. In the present specification, the term “sipe” means a slit having a width of 1.5 mm or less. When traveling on snow and ice, the inner-side portion 11 provides a large frictional force in the tire axial direction due to edges.

In order to achieve both good performance on snow and ice and good wear resistance of the shoulder land portions 7, it is desirable that a tire axial direction width (W4) of the inner-side portion 11 be, for example, 0.05-0.15 times the width (W1) of each of the shoulder land portions 7.

The outer-side portion 12, for example, has a width (W5) that is larger than the width (W4) of the inner-side portion 11. Specifically, it is desirable that the width (W5) of the outer-side portion 12 be, for example, 0.80-0.90 times the width (W1) of each of the shoulder land portions 7.

In each of the shoulder land portions 7, for example, multiple shoulder lug grooves 15 are provided at intervals along the tire circumferential direction and shoulder sipes 16 are respectively provided between the shoulder lug grooves 15.

The shoulder lug grooves 15 each extend at least from a tread edge (Te) toward a tire axial direction inner side. The shoulder lug grooves 15 each terminate without reaching the shoulder narrow groove 10. Such shoulder lug grooves 15 improve wet performance and performance on snow while maintaining the rigidity of the shoulder land portions 7 on an tire axial direction inner side.

It is desirable that connection sipes 17 be respectively provided on tire axial direction inner sides of the shoulder lug grooves 15, the connection sipes 17 respectively extending from inner ends (15i) of the shoulder lug grooves 15 across the respective shoulder narrow grooves 10 to reach the respective shoulder main grooves 3. Such connection sipes 17 suppress a strain of a ground contact portion of tire axial direction inner sides of the shoulder lug grooves 15 during traveling, and suppress uneven wear thereof.

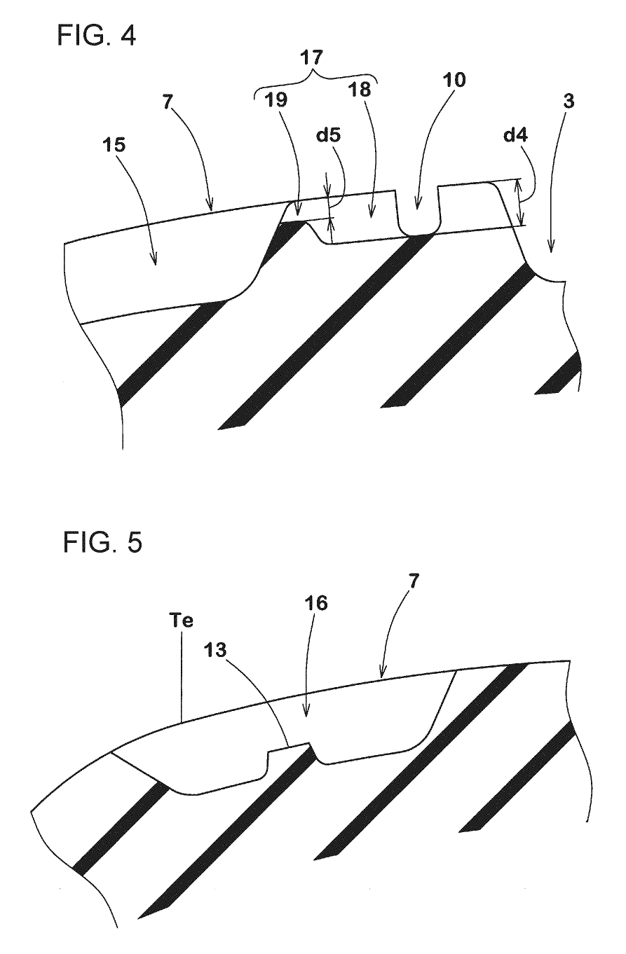

FIG. 4 illustrates a cross-sectional view of a B-B line along a length direction of a connection sipe 17 and a shoulder lug groove 15 of FIG. 3. As illustrated in FIG. 4, the connection sipe 17 includes a first portion 18 on a shoulder main groove 3 side, and a second portion 19 of which a bottom surface is raised higher than the first portion 18 on a tread edge (Te) side. Such connection sipes 17 suppress uneven wear of the shoulder land portions 7 near the inner ends of the shoulder lug grooves 15.

The first portion 18, for example, has a substantially constant depth (d4) and extends across the shoulder narrow groove 10. The depth (d4) of the first portion 18 is, for example, 2.5-3.5 mm. As a desirable mode, the first portion 18 has a depth equal to that of the shoulder narrow groove 10. This allows the steering stability on a dry road surface and performance on snow to be improved in a well-balanced manner.

The second portion 19 is provided between the first portion 18 and the shoulder lug groove 15. A depth (d5) of the second portion 19 is, for example, 0.40-0.60 times the depth (d4) of the first portion 18. Such a second portion 19 helps to increase the steering stability on a dry road surface while maintaining water absorption performance of the connection sipe 36.

As illustrated in FIG. 3, one or two shoulder sipes 16, for example, are provided between shoulder lug grooves (15, 15) that are adjacent to each other in the tire circumferential direction. The shoulder sipes 16 extends, for example, substantially parallel to the shoulder lug grooves 15.

The shoulder sipes 16, for example, each extend at least from a tread edge (Te) toward a tire axial direction inner side. The shoulder sipes 16, for example, each terminate without reaching the shoulder narrow groove 10. Such shoulder sipes 16 can maintain the rigidity of the shoulder land portions 7 and effectively improve the steering stability on a dry road surface and the wear resistance of the shoulder land portions 7.

FIG. 5 illustrates a cross-sectional view of a C-C line along a length direction of a shoulder sipe 16 of FIG. 3. As illustrated in FIG. 5, the shoulder sipe 16, for example, has a raised portion 13 of which a bottom surface is partially raised. Such a raised portion 13 can suppress opening of the shoulder sipe 16 and can enhance an edge effect thereof.

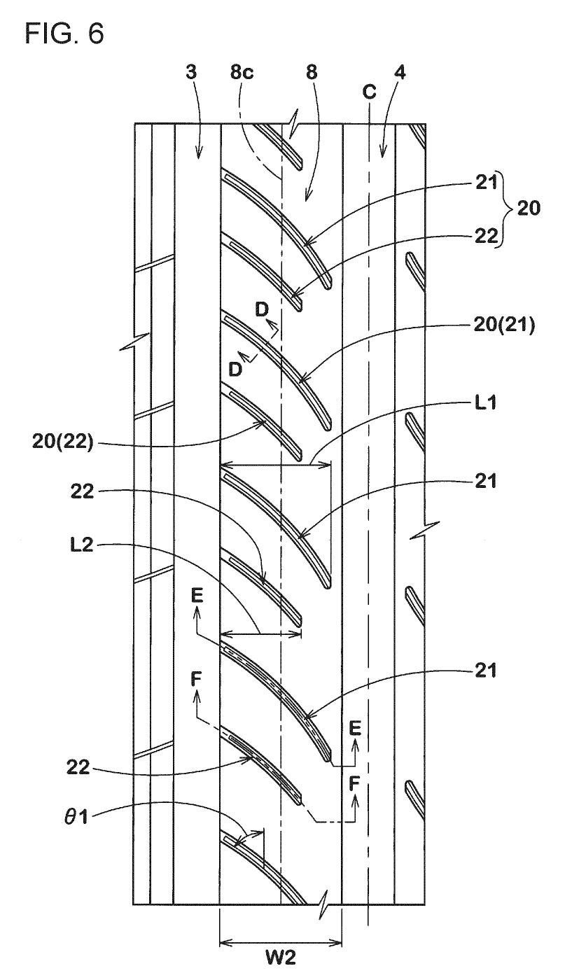

FIG. 6 illustrates an enlarged view of a middle land portion 8. As illustrated in FIG. 6, the tire axial direction width (W2) of the middle land portion 8, for example, is 0.15-0.20 times of the tread ground contact width (TW).

Multiple middle transverse grooves 20 are provided in the middle land portion 8. As a desirable mode, the middle land portion 8 is a rib that continuously extends in the tire circumferential direction in which there are no grooves for drainage other than the middle transverse grooves 20.

The middle transverse grooves 20 each extend from a shoulder main groove 3 obliquely with respect to the tire axial direction and terminate within the middle land portion 8. Such middle transverse grooves 20 each do not completely divide the middle land portion 8 and thus can maintain the rigidity of the middle land portion 8 and can improve the steering stability on a dry road surface.

The middle transverse grooves 20, for example, are inclined at an angle (θ1) of 35-65 degrees with respect to the tire circumferential direction. Such middle transverse grooves 20 achieve an edge effect in the tire circumferential direction and in the tire axial direction and improve the performance on snow and ice. As a desirable mode, for example, the angle (θ1) of the middle transverse grooves 20 with respect to the tire circumferential direction gradually decreases toward a tire axial direction inner side. Such middle transverse grooves 20 increase an edge component in the tire circumferential direction on a tire axial direction inner side where a large ground contact pressure acts. This effectively increases a frictional force in the tire axial direction on snow and ice.

It is desirable that the middle transverse grooves 20 each terminate, for example, on a tire axial direction inner side beyond a width direction center (8c) of the middle land portion 8. As a result, the edge component of the middle transverse grooves 20 increases and the performance on snow is further improved.

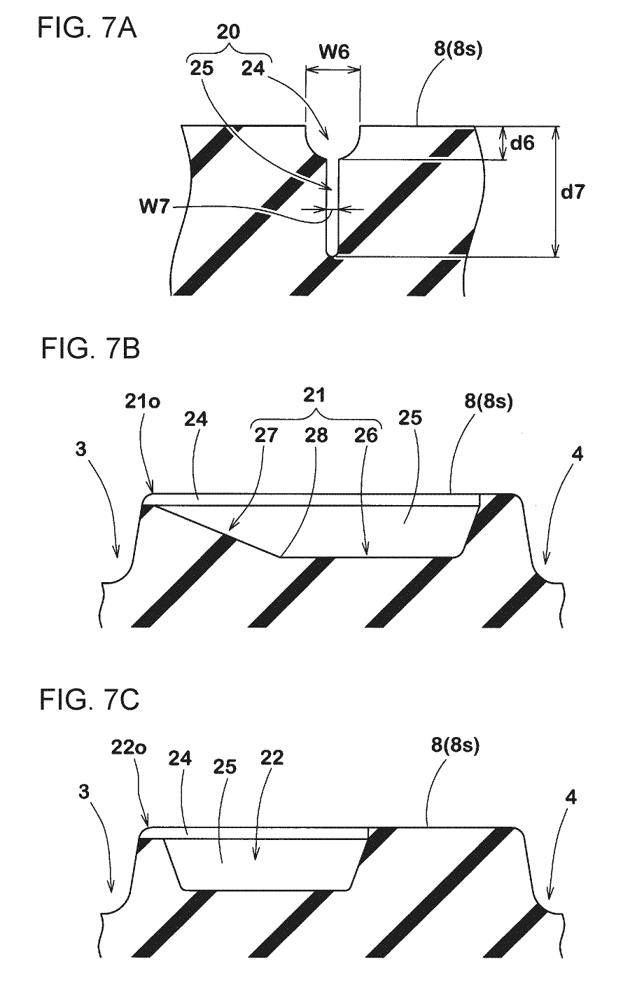

FIG. 7A illustrates a cross-sectional view along a D-D line orthogonal to a length direction of a middle transverse groove 20 of FIG. 6. As illustrated in FIG. 7A, the middle transverse groove 20, for example, has an outer-side portion 24 that opens on a tread surface side with a width (W6) of 1.0-2.5 mm and a groove bottom sipe 25 that extends from a bottom surface of the outer-side portion 24 toward a tire radial direction inner side. The middle transverse grooves 20 having such groove bottom sipes 25 can improve the wet performance while maintaining the rigidity of the middle land portions 8.

The outer-side portion 24, for example, has an arc-shaped contour that is convex toward a tire radial direction inner side in a cross section orthogonal to a length direction of the middle transverse groove 20. It is desirable that a depth (d6) of the outer-side portion 24, for example, be 0.5-1.5 mm.

In the present embodiment, a width (W7) of the groove bottom sipe 25 is preferably 0.3-0.7 mm. A depth (d7) from a tread surface (8s) of the middle land portion 8 to a bottom (25d) of the groove bottom sipe 25, for example, is 4.5-6.0 mm, and more preferably 5.0-5.5 mm. Such groove bottom sipes 25 can suppress a strain of ground contact surfaces of the middle land portions 8 and can suppress uneven wear thereof while maintaining the rigidity of the middle land portions 8.

As illustrated in FIG. 6, middle transverse grooves 20 include first middle transverse grooves 21, and second middle transverse grooves 22 that have a tire axial direction length shorter than that of the first middle transverse grooves 21. It is desirable that the first middle transverse grooves 21 and the second middle transverse grooves 22, for example, are alternately provided in the tire circumferential direction.

A tire axial direction length (L1) of each of the first middle transverse grooves 21 is preferably 0.50 or more and 0.95 or less times of the tire axial direction width (W2) of each of the middle land portions 8 and more preferably 0.70 or more and 0.90 or less times the tire axial direction width (W2) of each of the middle land portions 8.

FIG. 7B illustrates a cross-sectional view of an E-E line along a length direction of a first middle transverse groove 21 of FIG. 6. As illustrated in FIG. 7B, the first middle transverse grooves 21 each have a first portion 26 that has a substantially constant depth, and a second portion 27 that is gradually reduced in depth from the first portion 26 toward a shoulder main groove 3 side. Such first middle transverse grooves 21 help maintain rigidity of tire axial direction outer sides of the middle land portions 8 and maintain the steering stability on a dry road surface.

It is desirable that a boundary 28 between the first portion 26 and the second portion 27 be positioned on a tire axial direction outer side beyond the width direction center (8c) (illustrated in FIG. 6) of the middle land portion 8. Such a first portion 26 and a second portion 27 ensure a volume of the first middle transverse groove 21 and improve the water absorption performance of the sipes.

As particularly preferable mode, an outer end (21o) of the first middle transverse groove 21 is formed by the outer-side portion 24 only. That is, it is desirable that, while being gradually reduced in depth toward the tire axial direction outer side, the groove bottom sipe 25 of the first middle transverse groove 21 terminate before the shoulder main groove 3 without being communicatively connected to the shoulder main groove 3. Such first middle transverse grooves 21 can maintain the rigidity of the tire axial direction outer sides of the middle land portions 8 and suppress uneven wear thereof.

As illustrated in FIG. 6, a tire axial direction length (L2) of each of the second middle transverse grooves 22 is preferably 0.65 or more and 0.85 or less times of the tire axial direction length (L1) of each of the first middle transverse grooves 21, and more preferably 0.70 or more and 0.80 or less times the axial direction length (L1) of each of the first middle transverse grooves 21. Such first middle transverse grooves 21 and second middle transverse grooves 22 improve the steering stability on a dry road surface and the performance on snow and ice in a well-balanced manner.

FIG. 7C illustrates a cross-sectional view of an F-F line along a length direction of a second middle transverse groove 22 of FIG. 6. As illustrated in FIG. 7C, the second middle transverse groove 22 has a bottom surface that extends in the tire axial direction at a substantially constant depth. Such second middle transverse grooves 22 suppress a strain of a ground contact portion of the middle land portions 8, and suppress uneven wear thereof.

As preferable mode, an outer end (22o) of the second middle transverse groove 22 is formed by the outer-side portion 24 only. That is, it is desirable that the groove bottom sipe 25 of the second middle transverse groove 22 terminate before the shoulder main groove 3 without being communicatively connected to the shoulder main groove 3. Such second middle transverse grooves 22 can maintain the rigidity of the tire axial direction outer sides of the middle land portions 8 and suppress uneven wear thereof.

In the above, a pneumatic tire according to an embodiment of the present invention is described in detail. However, without being limited to the above-described specific embodiment, the present invention can also be embodied in various modified forms.

### EXAMPLES

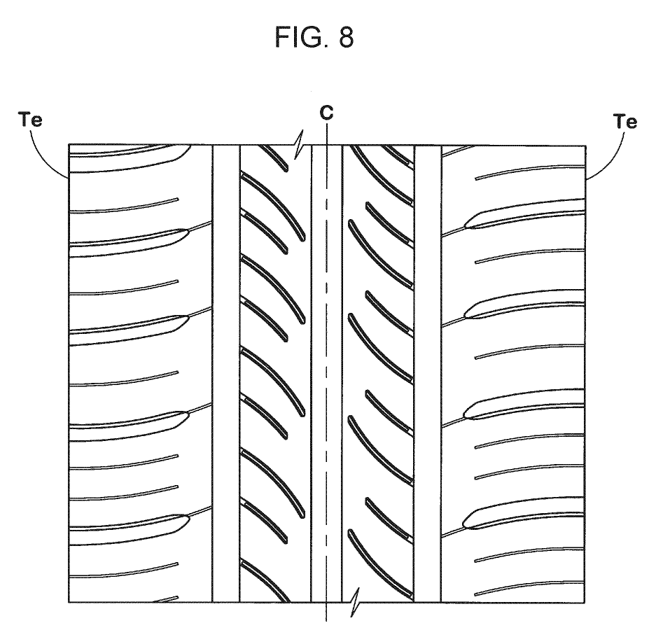

Pneumatic tires each having the basic pattern of FIG. 1 are prototyped based on specifications shown in Table 1. As Comparative Example 1, as illustrated in FIG. 8, a tire that does not have shoulder narrow grooves is prototyped. For each of the test tires, steering stability on a dry road surface, performance on snow and ice, and a wear amount of a shoulder portion are tested. Common specifications of the test tires are as follows.

Tire size: 185165R15

Rim size: 15×6.0 J

Tire internal pressure: front wheel: 220 kPa; rear wheel: 210 kPa

Tread ground contact width (TW): 132 mm

Groove width (W8) of shoulder main grooves and groove width (W9) of center main groove: 9.0 mm

Depth (d1) of shoulder main grooves and depth (d2) of center main groove: 7.4 mm

A test method is as follows.

### Steering Stability on Dry Road Surface

Steering stability when driving the following test vehicle on a test course of a dry road surface is evaluated by the driver based on a sensory evaluation. The result is a score with a result of Comparative Example 1 as 100. A larger score indicates a better steering stability.

Test vehicle: displacement: 1300 cc; front wheel drive

Test tire mounting positions: all wheels

### Performance on Snow and Ice

Performance on snow and ice when driving the test vehicle on snow and ice with chains installed on the front wheels of the test vehicle is evaluated by the driver based sensory evaluation. The result is a score with a result of Comparative Example 1 as 100. A larger score indicates that occurrence of sideslip is less frequent and the performance on snow and ice is superior.

### Wear Amount of Shoulder Land Portions

After the test vehicle is driven a predetermined distance on a dry road surface, a wear amount of a shoulder land portion is measured. The result is an index number with a wear amount of a shoulder land portion of Comparative Example 1 as 100. A smaller index number indicates that the wear amount of the shoulder land portion is smaller The test results are shown in Table 1.

TABLE 1

| | Comparative | Comparative | | | | | | Comparative |
|---|---|---|---|---|---|---|---|---|
| | Example 1 | Example 2 | Example 1 | Example 2 | Example 3 | Example 4 | Example 5 | Example 3 |
| Figure Illustrating Tread Pattern | FIG. 8 | FIG. 1 | FIG. 1 | FIG. 1 | FIG. 1 | FIG. 1 | FIG. 1 | FIG. 1 |
| Shoulder Land Portion Width (W1)/ | 2.0 | 1.5 | 2.0 | 1.6 | 1.8 | 2.2 | 2.4 | 2.5 |
| Middle Land Portion Width (W2) | | | | | | | | |
| First Camber Amount (C1)/ | 6.0 | 6.0 | 6.0 | 6.0 | 6.0 | 6.0 | 6.0 | 6.0 |
| Tread Ground Contact Width (TW) (%) | | | | | | | | |
| Second Camber Amount (C2)/ | 1.2 | 1.2 | 1.2 | 1.2 | 1.2 | 1.2 | 1.2 | 1.2 |
| Tread Ground Contact Width (TW) (%) | | | | | | | | |
| Shoulder Narrow Groove Width (W3)/ | 1.0 | 1.0 | 1.0 | 1.0 | 1.0 | 1.0 | 1.0 | 1.0 |
| Tread Ground Contact Width (TW) (%) | | | | | | | | |
| Shoulder Narrow Groove Depth (d3)/ | 0.40 | 0.40 | 0.40 | 0.40 | 0.40 | 0.40 | 0.40 | 0.40 |
| Shoulder Main Groove Depth (d1) (%) | | | | | | | | |
| Inner-Side Portion Width (W)/ | 3.6 | 3.6 | 3.6 | 3.6 | 3.6 | 3.6 | 3.6 | 3.6 |
| Tread Ground Contact Width (TW) (%) | | | | | | | | |
| Dry Road Surface Steering Stability | 100 | 93 | 101 | 102 | 101 | 100 | 98 | 98 |
| (Score) | | | | | | | | |
| Performance on Snow and Ice (Score) | 100 | 108 | 112 | 109 | 110 | 108 | 107 | 102 |
| Shoulder Land Portion Wear Amount | 100 | 107 | 100 | 100 | 100 | 100 | 99 | 98 |
| (Index Number) | | | | | | | | |

| | Comparative | | | | | Comparative | | |
|---|---|---|---|---|---|---|---|---|
| | Example 4 | Example 6 | Example 7 | Example 8 | Example 9 | Example 5 | Example 10 | Example 11 |
| Figure Illustrating Tread Pattern | FIG. 1 | FIG. 1 | FIG. 1 | FIG. 1 | FIG. 1 | FIG. 1 | FIG. 1 | FIG. 1 |
| Shoulder Land Portion Width (W1)/ | 2.0 | 2.0 | 2.0 | 2.0 | 2.0 | 2.0 | 2.0 | 2.0 |
| Middle Land Portion Width (W2) | | | | | | | | |
| First Camber Amount (C1)/ | 5.0 | 5.3 | 5.6 | 6.2 | 6.5 | 7.0 | 6.0 | 6.0 |
| Tread Ground Contact Width (TW) (%) | | | | | | | | |
| Second Camber Amount (C2)/ | 1.2 | 1.2 | 1.2 | 1.2 | 1.2 | 1.2 | 0.5 | 1.0 |
| Tread Ground Contact Width (TW) (%) | | | | | | | | |
| Shoulder Narrow Groove Width (W3)/ | 1.0 | 1.0 | 1.0 | 1.0 | 1.0 | 1.0 | 1.0 | 1.0 |
| Tread Ground Contact Width (TW) (%) | | | | | | | | |
| Shoulder Narrow Groove Depth (d3)/ | 0.40 | 0.40 | 0.40 | 0.40 | 0.40 | 0.40 | 0.40 | 0.40 |
| Shoulder Main Groove Depth (d1) (%) | | | | | | | | |
| Inner-Side Portion Width (W)/ | 3.6 | 3.6 | 3.6 | 3.6 | 3.6 | 3.6 | 3.6 | 3.6 |
| Tread Ground Contact Width (TW) (%) | | | | | | | | |
| Dry Road Surface Steering Stability | 100 | 100 | 101 | 100 | 100 | 96 | 102 | 102 |
| (Score) | | | | | | | | |
| Performance on Snow and Ice (Score) | 107 | 110 | 111 | 112 | 108 | 104 | 107 | 109 |
| Shoulder Land Portion Wear Amount | 105 | 101 | 100 | 100 | 99 | 98 | 101 | 100 |
| (Index Number) | | | | | | | | |

| | | | | | | | Example | Example |
|---|---|---|---|---|---|---|---|---|
| | Example 12 | Example 13 | Example 14 | Example 15 | Example 16 | Example 17 | 18 | 19 |
| Figure Illustrating Tread Pattern | FIG. 1 | FIG. 1 | FIG. 1 | FIG. 1 | FIG. 1 | FIG. 1 | FIG. 1 | FIG. 1 |
| Shoulder Land Portion Width (W1)/ | 2.0 | 2.0 | 2.0 | 2.0 | 2.0 | 2.0 | 2.0 | 2.0 |
| Middle Land Portion Width (W2) | | | | | | | | |
| First Camber Amount (C1)/ | 6.0 | 6.0 | 6.0 | 6.0 | 6.0 | 6.0 | 6.0 | 6.0 |
| Tread Ground Contact Width (TW) (%) | | | | | | | | |
| Second Camber Amount (C2)/ | 2.0 | 2.5 | 1.2 | 1.2 | 1.2 | 1.2 | 1.2 | 1.2 |
| Tread Ground Contact Width (TW) (%) | | | | | | | | |
| Shoulder Narrow Groove Width (W3)/ | 1.0 | 1.0 | 0.5 | 0.8 | 1.2 | 1.5 | 1.0 | 1.0 |
| Tread Ground Contact Width (TW) (%) | | | | | | | | |
| Shoulder Narrow Groove Depth (d3)/ | 0.40 | 0.40 | 0.40 | 0.40 | 0.40 | 0.40 | 0.34 | 0.38 |
| Shoulder Main Groove Depth (d1) (%) | | | | | | | | |
| Inner-Side Portion Width (W)/ | 3.6 | 3.6 | 3.6 | 3.6 | 3.6 | 3.6 | 3.6 | 3.6 |
| Tread Ground Contact Width (TW) (%) | | | | | | | | |
| Dry Road Surface Steering Stability | 101 | 100 | 103 | 102 | 100 | 98 | 101 | 101 |
| (Score) | | | | | | | | |
| Performance on Snow and Ice (Score) | 111 | 110 | 106 | 108 | 112 | 114 | 108 | 112 |
| Shoulder Land Portion Wear Amount | 100 | 99 | 100 | 100 | 101 | 102 | 99 | 100 |
| (Index Number) | | | | | | | | |

| | Example 20 | Example 21 | Example 22 | Example 23 | Example 24 | Example 25 |
|---|---|---|---|---|---|---|
| Figure Illustrating Tread Pattern | FIG. 1 | FIG. 1 | FIG. 1 | FIG. 1 | FIG. 1 | FIG. 1 |
| Shoulder Land Portion Width (W1)/ | 2.0 | 2.0 | 2.0 | 2.0 | 2.0 | 2.0 |
| Middle Land Portion Width (W2) | | | | | | |
| First Camber Amount (C1)/ | 6.0 | 6.0 | 6.0 | 6.0 | 6.0 | 6.0 |
| Tread Ground Contact Width (TW) (%) | | | | | | |
| Second Camber Amount (C2)/ | 1.2 | 1.2 | 1.2 | 1.2 | 1.2 | 1.2 |
| Tread Ground Contact Width (TW) (%) | | | | | | |
| Shoulder Narrow Groove Width (W3)/ | 1.0 | 1.0 | 1.0 | 1.0 | 1.0 | 1.0 |
| Tread Ground Contact Width (TW) (%) | | | | | | |
| Shoulder Narrow Groove Depth (d3)/ | 0.42 | 0.47 | 0.40 | 0.40 | 0.40 | 0.40 |
| Shoulder Main Groove Depth (d1) (%) | | | | | | |
| Inner-Side Portion Width (W)/ | 3.6 | 3.6 | 3.3 | 3.5 | 3.7 | 3.9 |
| Tread Ground Contact Width (TW) (%) | | | | | | |
| Dry Road Surface Steering Stability | 100 | 98 | 99 | 100 | 102 | 102 |
| (Score) | | | | | | |
| Performance on Snow and Ice (Score) | 113 | 113 | 112 | 112 | 110 | 109 |
| Shoulder Land Portion Wear Amount | 102 | 103 | 101 | 101 | 100 | 99 |
| (Index Number) | | | | | | |

As a result of the tests, it can be confirmed that the pneumatic tires of the examples allowed the performance on snow and ice and the durability of the shoulder land portions to be improved.

In the pneumatic tire of Japanese Patent Laid-Open Publication No. HEI 9-277804, in a tread profile, a camber amount, which is a tire radial direction distance between a tire equator position and a tread edge, is set to be as small as 5% or less of a tread ground contact width. Such a pneumatic tire tends to have a large ground contact pressure acting on the shoulder land portions. This tendency becomes prominent as rigidity of the shoulder land portions is reduced by the shoulder narrow grooves, and there is a problem that premature wear occurs in the shoulder land portions.

A pneumatic tire according to an embodiment of the present invention can improve wear resistance of a shoulder land portion while suppressing sideslip on snow and ice based on improving a ratio of a width of a shoulder land portion to a width of a middle land portion, a camber amount at a tread edge, and the like.

A pneumatic tire according to an embodiment of the present invention has a tread part. By providing, in the tread part, a shoulder main groove that continuously extends in a tire circumferential direction on a tread edge side and a center main groove that continuously extends in the tire circumferential direction on a tire axial direction inner side of the shoulder main groove, the tread part is divided into a shoulder land portion on a tire axial direction outer side of the shoulder main groove and a middle land portion between the shoulder main groove and the center main groove. A ratio (W1/W2) of a tire axial direction width (W1) of the shoulder land portion to a tire axial direction width (W2) of the middle land portion is 1.6-2.4. A shoulder narrow groove that continuously extends in the tire circumferential direction with a groove width smaller than that of the shoulder main groove is provided in the shoulder land portion on the shoulder main groove side. A first camber amount, which is a tire radial direction distance between a tire equator position and the tread edge in a tread profile in a tire cross section that includes a tire rotation axis in a no-load normal state in which the pneumatic tire is mounted to a normal rim and is filled with air at a normal internal pressure, is 5.3%-6.5% of a tread ground contact width.

In a pneumatic tire according to an embodiment of the present invention, it is desirable that a second camber amount, which is a tire radial direction distance between the tire equator position and a groove center position of the shoulder narrow groove in the tread profile, be 0.5%-2.5% of the tread ground contact width.

In a pneumatic tire according to an embodiment of the present invention, it is desirable that a groove width of the shoulder narrow groove be 0.5%-1.5% of the tread ground contact width.

In a pneumatic tire according to an embodiment of the present invention, it is desirable that a depth of the shoulder narrow groove be 0.34-0.47 times a depth of the shoulder main groove.

In a pneumatic tire according to an embodiment of the present invention, it is desirable that the shoulder land portion include an inner-side portion between the shoulder main groove and the shoulder narrow groove, and a tire axial direction width of the inner-side portion be 3.3%-3.9% of the tread ground contact width.

In a pneumatic tire according to an embodiment of the present invention, it is desirable that multiple middle transverse grooves that each extend from the shoulder main groove obliquely with respect to the tire axial direction and terminate within the middle land portion are provided in the middle land portion, and the middle transverse grooves include first middle transverse grooves, and second middle transverse grooves that have a tire axial direction length shorter than that of the first middle transverse grooves.

In a pneumatic tire according to an embodiment of the present invention, it is desirable that the middle transverse grooves each include an outer-side portion that has a width of 1.0-2.5 mm and a groove bottom sipe that extends from a bottom surface of the outer-side portion toward a tire radial direction inner side, and the groove bottom sipe of each of the first middle transverse grooves include a first portion that has a constant depth and a second portion that is gradually reduced in depth from the first portion toward the shoulder main groove.

In a pneumatic tire according to an embodiment of the present invention, the ratio (W1/W2) of the tire axial direction width (W1) of the shoulder land portion to the tire axial direction width (W2) of the middle land portion is 1.6-2.4. The shoulder land portion having the width as large as 1.6-2.4 times the width of the middle land portion tends to have a higher rigidity than the middle land portion and thus can achieve excellent wear resistance. Further, in the shoulder land portion, on the shoulder main groove side, the shoulder narrow groove that continuously extends in the tire circumferential direction with the groove width smaller than that of the shoulder main groove is provided. When traveling on snow and ice, the shoulder narrow groove provides a large frictional force in the tire axial direction by edges in the shoulder land portion that has a large width, thus helping to prevent sideslip on snow and ice.

In a pneumatic tire according to an embodiment of the present invention, the first camber amount, which is the tire radial direction distance between the tire equator position and the tread edge in the tread profile in the tire cross section that includes the tire rotation axis in the no-load normal state in which the pneumatic tire is mounted to a normal rim and is filled with air at a normal internal pressure, is 5.3%-6.5% of the tread ground contact width.

When the first camber amount is small, a ground contact pressure acting on the shoulder land portion tends to be large. On the other hand, when the first camber amount is large, the ground contact pressure acting on the shoulder land portion tends to decrease and a ground contact pressure acting on the middle land portion tends to increase. In a conventional pneumatic tire, the first camber amount is often set to 5.0% or less of the tread ground contact width. In this case, a relatively large ground contact pressure is likely to act on the shoulder land portion, and thus the shoulder land portion tends to wear out earlier than the middle land portion.

An optimal first camber amount for making a wear amount of the shoulder land portion and a wear amount of the middle land portion substantially uniform can vary depending on and has a certain relationship with the ratio of the width of the shoulder land portion to the width of the middle land portion.

In an embodiment of the present invention, the width of the shoulder land portion is specified in the above-described range relative to the width of the middle land portion, and the first camber amount is set to be as large as 5.3%-6.5% of the tread ground contact width. As a result, distribution of ground contact pressure acting on the shoulder land portion and the middle land portion is optimized and thus progress of wear in both land portions becomes substantially uniform. Therefore, the wear resistance of the shoulder land portion can be improved.

Obviously, numerous modifications and variations of the present invention are possible in light of the above teachings. It is therefore to be understood that within the scope of the appended claims, the invention may be practiced otherwise than as specifically described herein.

1. A pneumatic tire, comprising:
a tread having a shoulder main groove continuously extending in a tire circumferential direction on a tread edge side, and a center main groove continuously extending in the tire circumferential direction on a tire axial direction inner side of the shoulder main groove such that the tread is divided into a shoulder land portion on a tire axial direction outer side of the shoulder main groove and a middle land portion between the shoulder main groove and the center main groove,
wherein the shoulder main groove and center main groove are formed such that a ratio W1/W2 of a tire axial direction width W1 of the shoulder land portion to a tire axial direction width W2 of the middle land portion is in a range of 6 to 2.4, the shoulder land portion has a shoulder narrow groove formed on a shoulder main groove side and continuously extending in the tire circumferential direction such that the shoulder narrow groove has a groove width smaller than a groove width of the shoulder main groove, and the tread is formed such that a first camber amount is in a range of 5.3% to 6.5% of a tread ground contact width, where the first camber amount is a tire radial direction distance between a tire equator position and a tread edge in a tread profile in a tire cross section that includes a tire rotation axis in a no-load normal state in which the pneumatic tire is mounted to a normal rim and is filled with air at a normal internal pressure.

2. The pneumatic tire according to claim 1, wherein the tread is formed such that a second camber amount is in a range of 0.5% to 2.5% of the tread ground contact width, where which the second camber amount is a tire radial direction distance between the tire equator position and a groove center position of the shoulder narrow groove in the tread profile.

3. The pneumatic tire according to claim 1, wherein the shoulder narrow groove has a groove width which is in a range of 0.5% to 1.5% of the tread ground contact width.

4. The pneumatic tire according to claim 1, wherein the shoulder narrow groove has a depth which is in a range of 0.34 to 0.47 times a depth of the shoulder main groove.

5. The pneumatic tire according to claim 1, wherein the shoulder land portion includes an inner-side portion formed between the shoulder main groove and the shoulder narrow groove such that a tire axial direction width of the inner-side portion is in a range of 3.3% to 3.9% of the tread ground contact width.

6. The pneumatic tire according to claim 1, wherein the middle land portion has a plurality of middle transverse grooves such that each of the middle transverse grooves is extending from the shoulder main groove obliquely with respect to the tire axial direction and terminated within the middle land portion, and the plurality of middle transverse grooves includes a plurality of first middle transverse grooves and a plurality of second middle transverse grooves such that the second middle transverse grooves have a tire axial direction length shorter than a tire axial direction length t of the first middle transverse grooves.

7. The pneumatic tire according to claim 6, wherein each of the middle transverse grooves includes an outer-side portion and a groove bottom sipe such that the outer-side portion has a width in a range of 1.0 to 2.5 mm and that the groove bottom sipe is extending from a bottom surface of the outer-side portion toward a tire radial direction inner side, and the groove bottom sipe of each of the first middle transverse grooves includes a first portion having a constant depth and a second portion being gradually reduced in depth from the first portion toward the shoulder main groove.

8. The pneumatic tire according to claim 1, wherein the shoulder land portion has a plurality of shoulder lug grooves formed at intervals along the tire circumferential direction such that each of the shoulder lug grooves is extending at least from a tread edge toward a tire axial direction inner side and terminated without reaching the shoulder narrow groove, and the shoulder lug grooves has a plurality of connection sipes on tire axial direction inner sides of the shoulder lug grooves respectively such that the plurality of connection sipes is extending from inner ends of the shoulder lug grooves across the shoulder narrow groove to reach the shoulder main groove and that each of the connection sipes includes a first portion on a shoulder main groove side, and a second portion having a bottom surface which is raised higher than the first portion on the tread edge side.

9. The pneumatic tire according to claim 8, wherein each of the connection sipes is formed such that the second portion is formed between the first portion and the shoulder lug groove such that a depth of the second portion is in a range of 0.40 to 0.60 times a depth of the first portion.

10. The pneumatic tire according to claim 8, wherein the shoulder land portion has at least one shoulder sipe formed between adjacent shoulder lug grooves in the tire circumferential direction such that the shoulder sipe is extending substantially parallel to the shoulder lug grooves at least from the tread edge toward the tire axial direction inner side.

11. The pneumatic tire according to claim 8, wherein the shoulder land portion has at least one shoulder sipe formed between adjacent shoulder lug grooves in the tire circumferential direction such that the shoulder sipe is extending substantially parallel to the shoulder lug grooves at least from the tread edge toward the tire axial direction inner side and terminated without reaching the shoulder narrow groove.

12. The pneumatic tire according to claim 10, wherein the shoulder sipe has a raised portion having a partially raised bottom surface.

13. The pneumatic tire according to claim 1, wherein the middle land portion has a plurality of middle transverse grooves such that each of the middle transverse grooves is extending from the shoulder main groove obliquely with respect to the tire axial direction and terminated within the middle land portion.

14. The pneumatic tire according to claim 13, wherein the middle transverse grooves are inclined at an angle θ1 in a range of 35 to 65 degrees with respect to the tire circumferential direction.

15. The pneumatic tire according to claim 14, wherein the middle transverse grooves are inclined at the angle θ1 such that the angle θ1 is gradually decreasing toward the tire axial direction inner side.

16. The pneumatic tire according to claim 1, wherein the middle land portion has a plurality of middle transverse grooves such that each of the middle transverse grooves is extending from the shoulder main groove obliquely with respect to the tire axial direction and terminated on the tire axial direction inner side beyond a width direction center of the middle land portion.

17. The pneumatic tire according to claim 2, wherein the shoulder narrow groove has a groove width which is in a range of 0.5% to 1.5% of the tread ground contact width.

18. The pneumatic tire according to claim 2, wherein the shoulder narrow groove has a depth which is in a range of 0.34 to 0.47 times a depth of the shoulder main groove.

19. The pneumatic tire according to claim 2, wherein the shoulder land portion includes an inner-side portion formed between the shoulder main groove and the shoulder narrow groove such that a tire axial direction width of the inner-side portion is in a range of 3.3% to 3.9% of the tread ground contact width.

20. The pneumatic tire according to claim 2, wherein the middle land portion has a plurality of middle transverse grooves such that each of the middle transverse grooves is extending from the shoulder main groove obliquely with respect to the tire axial direction and terminated within the middle land portion, and the plurality of middle transverse grooves includes a plurality of first middle transverse grooves and a plurality of second middle transverse grooves such that the second middle transverse grooves have a tire axial direction length shorter than a tire axial direction length t of the first middle transverse grooves.
